(19) United States
(12) Patent Application Publication
(10) Pub. No.: US 2026/0301317 A1
(43) Pub. Date: Oct. 1, 2026

(54) GRAPH REPRESENTATION OF EVENTS FOR INTERACTIVE ENVIRONMENTS

(71) Applicant: InterDigital CE Patent Holdings, SAS, Paris (FR)

(72) Inventors: João Pedro COVA REGATEIRO, CHATEAUBOURG (FR); Patrice HIRTZLIN, BETTON (FR); Pierrick JOUET, RENNES (FR); Philippe GUILLOTEL, VERN SUR SEICHE (FR)

(21) Appl. No.: 19/476,053

(22) PCT Filed: Apr. 12, 2024
(86) PCT No.: PCT/EP2024/059985

§ 371 Date: Oct. 16, 2025

(30) Foreign Application Priority Data
Apr. 17, 2023 (EP) 23305581.3

(51) Int. Cl. G06T 17/00

(52) U.S. Cl. CPC G06T 17/005

(57) ABSTRACT

The present principles relate to a method for evaluating cascading events in an extended reality scene. The method comprises obtaining a scene description comprising a scene graph associated with a list of behaviors. A behavior can be a root behavior or can be a child of at least one behavior. The method comprises activating root behaviors. For each activated behavior, the method comprises activating root triggers of the graph of triggers of the activated behavior. When conditions of activated triggers are reached, the children of the activated triggers are activated, if they exist, and the current activated triggers is inactivated. Or, if there is no child, the actions of the graph of actions of the activated behavior are executed. When the actions are executed, the child behaviors of the activated behavior, if they exist, are activated at their time and the activated behavior is inactivated.

### CROSS REFERENCE TO RELATED APPLICATIONS

This application claims the benefit of European Application No. 23305581.3, filed on Apr. 17, 2023, which is incorporated herein by reference in its entirety.

### 1. TECHNICAL FIELD

The present principles generally relate to the domain of interactivity within 3D virtual environments. The present document is also understood in the context of the cascade events, such as triggers, actions, and behaviors, with the objective of creating a hierarchical connected graph of events between objects in a virtual scene. In particular, the present document relates to the generating of cascading events and the linking of any combinations of triggers, actions, and behaviors in an interactivity framework.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way that is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking nodes describing virtual objects and actions on these virtual objects on one hand, and binary representations of the virtual content on the other hand. Binary representation of real objects may also be comprised in nodes of the scene description. Such representations of real object may have been obtained, for example by scanning the real environment. Scene description frameworks ensure that the timed media and the corresponding relevant virtual content are available at any time during the rendering of the application. Scene descriptions can also carry data at scene level describing of how the scene objects behave and interact at runtime for immersive XR experiences. Some actions on virtual objects are triggered by proximity triggers.

Existing interactivity support at the scene or node level supports a limited set of triggers and actions. The triggers and actions are parts of behavior that define the relation between triggers and actions, the control parameters of the pair, priority terms and an option interrupt action. The control parameter “triggerCombinationControl” allows a set of logical operators to act upon the triggers (e.g., it is possible to use the logical operators “and”, “or” and “not” to activate the triggers/actions). Although, it is not possible to condition the behavior on a hierarchical structure, for example using cascading events on either behaviors, triggers, or actions. Then ability to activate an event depending on the validation and completion of the previous event actions does not currently exist in the current interactivity standards and is a powerful and useful attribute to have for interactivity with 3D environments. So, there is a lack for a mechanism to enable graphs structures on behavior, trigger, and action, to permit cascading events in 3D interactive scenes.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method for evaluating cascading events in an extended reality scene. The method comprises obtaining a scene description comprising a scene graph associated with a list of behavior elements. The scene graph links nodes describing virtual objects of the extended reality scene and a behavior element associates a graph of combinations of trigger elements with a graph of action elements. A behavior element can be a root behavior element or can be a child of at least one behavior element. The method further comprises activating root behavior elements. For each activated behavior element, the method comprises activating root trigger combinations of the graph of combinations of triggers of the activated behavior element. When conditions of activated trigger combinations are reached, the children of the activated combination of trigger element are activated, if they exist, and the current activated combination of trigger elements is inactivated. Or, if there is no child, the actions of the graph of action elements of the activated behavior element are executed. When the actions are executed, the child behavior elements of the activated behavior element, if they exist, are activated at their time and the activated behavior is inactivated.

In an embodiment, a sequential mode is set up and wherein a behavior element, a trigger element or an action element is activated only when a previous sibling element is inactivated. In another embodiment, a parallel mode is set up and wherein every child of a behavior element, a trigger element or an action element is activated when the element is inactivated.

The present principles also relate to a device comprising a memory associated with a processor configured for implementing the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 shows an example graph 10 of an extended reality scene description;

FIG. 2 shows four situations of a dynamic scene;

FIG. 3 shows an example architecture of a device which may be configured to implement a method for encoding or decoding a point cloud according to the present principles;

FIG. 4 shows an example of an embodiment of the syntax of a stream when the data are transmitted over a packet-based transmission protocol;

FIG. 5 diagrammatically illustrates behaviors, triggers and actions handling cascading events for a scene as illustrated in FIG. 1, according to the present principles;

FIG. 6 illustrates a method for processing a trigger graph according to the present principles;

FIG. 7 is a representation of the processing model for the cascading events using a graph structure according to the present principles;

FIG. 8 illustrates the validation model to use prior to the execution of a scene description file according to the present principles

FIG. 9 illustrates a state validation model to evaluate the state of the hierarchical triggers conditions.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

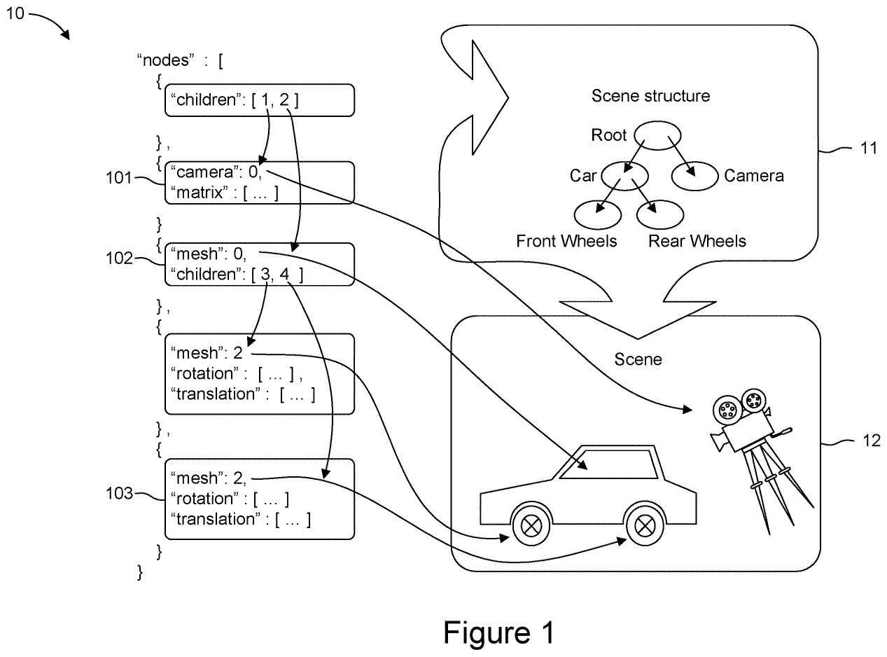

FIG. 1 shows an example graph 10 of an extended reality scene description. In this example, the scene graph may comprise descriptions of real objects, for example ‘plane horizontal surface’ (that can be a table or a road) and descriptions of virtual objects 12, for example an animation of a car. Scene description is organized as an array 10 of nodes. A node can be linked to child nodes to form a scene structure 11. A node can carry a description of a real object (e.g. a semantic description) or a description of a virtual object. In the example of FIG. 1, node 101 describes a virtual camera located in the 3D volume of the XR application. Node 102 described a virtual car and comprises an index of a representation of the car, for example an index in an array of 3D meshes. This representation may have been obtained, for example, by a scanning of the real environment or, for example, may be a model generated by a content creator. This representation corresponds to the object described in this node, and, so, is localized in the 3D scene.

The scene description may comprise numerous arrays comprising descriptions of various aspect of the scene, for example an array containing instructions for several animations, an array containing meshes of several virtual or real objects or an array comprising material descriptions. It also may comprise a description of actions to apply to virtual objects when an event occurs to these objects when playing the XR application, for example when an object controlled by a human user touches a virtual object to push it or to grab it, more generally when virtual objects collide or approaches other virtual objects or boundaries of the scene. Node 103 is a child of node 102 and comprises a description of one wheel of the car. The same way, it comprises an index to the 3D mesh of the wheel. The same 3D mesh may be used for several objects in the 3D scene as the scale, location and orientation of objects are described in the scene nodes. Scene graph 10 also comprises nodes that are a description of the spatial relation between the virtual objects.

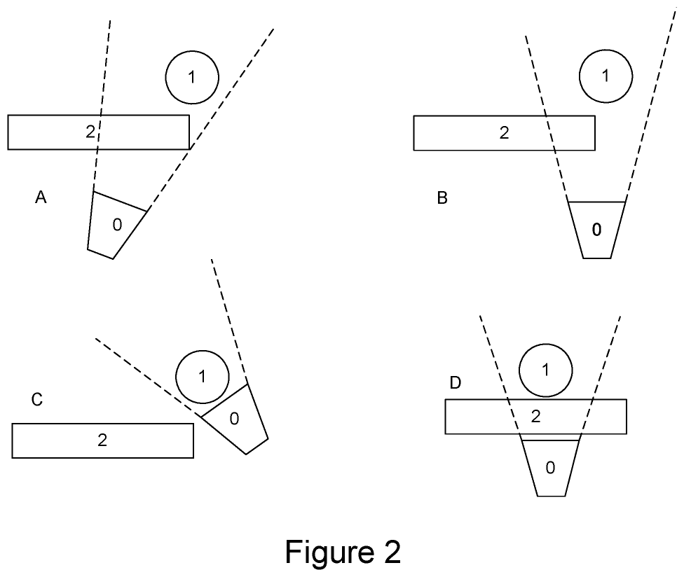

FIG. 2 shows four situations A, B, C and D of a dynamic scene. The scene comprises three objects: a camera 0, a ball 1 and a wall 2. In this example scenario, ball 1 is transformed (for example it rotates or translate or is rescaled) when it is visible from the camera and the material of ball 1 changes when the camera is close enough (for example closer than 1 meter) but only if it visible from camera 0. In situation A, ball 1 is not visible from camera 0 because it is occulted by wall 2. In situation B, ball 1 is visible from camera 2 but far from it, so the ball is transformed but keeps its material. In situation C, the ball is visible and close to the camera, so it is transformed and its material changes. In situation D, ball 1 is close enough to camera 0 but it is not visible, so nothing happens. Such a scenario can be represented with cascading events.

According to the present principles, a 3D scene and the interactivity of virtual objects within the 3D scene are represented by a scene graph. Herein, the format proposed according to the present principles follows the glTF format and is compatible with the current MPEG effort to extend glTF with MPEG extensions. However, the meaning and use is generic and can be coded with any other formats (e.g. XML, USD, . . . ). The scene graph comprises nodes that represent virtual objects and their relations, triggers that represent conditions to activate behaviors and actions that are applied to virtual objects. Objects, triggers, actions and behaviors are stored in arrays and are designated by their index in their array.

According to the present principles, an attribute “parent” and an attribute “children are set in triggers, actions and behaviors. These two attributes are an array of the indices of elements of the same type. So, the attribute parent of a trigger is an array of indices of other triggers. A special value, for example −1, is used to indicate that an element is a root element (that is it has no parent). An element cannot be its own parent or its own child. The parents and children of elements form a graph. Cycles in this graph are not allowed to avoid infinite loops. Triggers, actions and behavior also comprise a string attribute “timestamp” which represents the application time when the element has been initiated. This will safeguard the graph at runtime to restrict the children from being initiating or referenced by a parent twice. This is an optional attribute but is important to guarantee the normal behavior of the application.

For the three types of elements (triggers, actions, behavior) the graph is proceed when an event is detected. The event is always initiated at a root behavior element and propagated to its children. The event is propagated when the parent element has launched its actions, otherwise wait for the actions to be launched. The children can be initiated in two modes: “Parallel” or “Sequential”. In Parallel mode, all children are run in parallel and propagate the event to their own children only when their siblings (initiated in parallel) have launched their actions. In Sequential mode, if the array of children has more than one element, the “i+1” element is initiated when the previous “i” element has finished cascading the event to an end-leaf node. The graph processing ends when all end-leaf elements have finished their action events.

The parent and children attributes semantics are summarized in the following table, where ‘O’ stands for “optional”.

| Name | Type | Usage | Default | Description |
|---|---|---|---|---|
| parent | array | O | [−1] | Index of the parent elements. [−1] by default to |
| | | | | indicate that it is a root element. |
| children | array | O | [ ] | Indices of the children elements. The array is |
| | | | | executed in a sequential or parallel fashion, if the |
| | | | | conditions are not met for index i, index i + 1 is not |
| | | | | processed. The element at index i + 1 is computed |
| | | | | when its precedent is valid at least once and the |
| | | | | actions are launched. |
| timestamp | string | O | “” | Timestamp of the activation of the element using |
| | | | | the application runtime. |

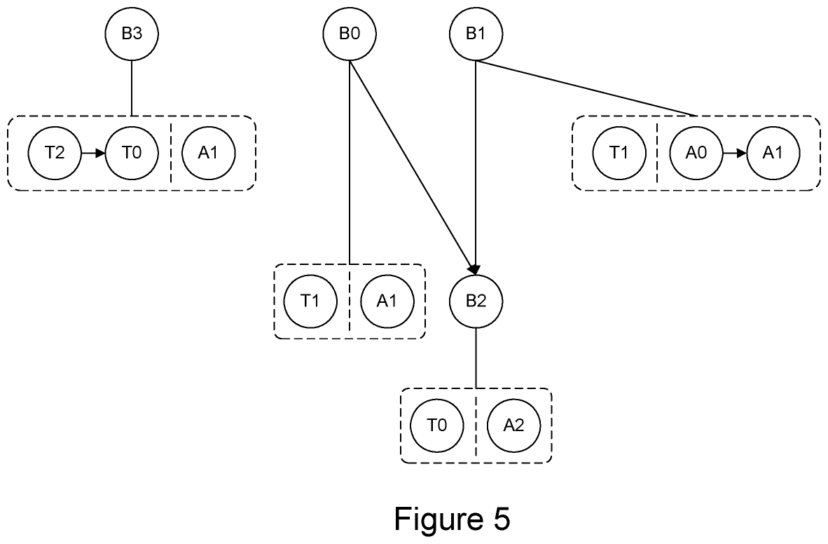

FIG. 5 diagrammatically illustrates behaviors, triggers and actions handling cascading events for a scene as illustrated in FIG. 1, according to the present principles. Multiple instantiations are possible, this example is provided for illustration purposes. The array of behaviors comprises three root behaviors B0, B1 and B3 with one child behavior B2 referencing 2 parent nodes B0 and B1. The trigger array comprises two root triggers T1 and T2 and one child trigger TO referencing T2 as its parent. The action array comprises two actions A0 and A2 and one child action A1 referencing A0 as its parent. When T1 is triggered, behaviors B0 is activated and action A1 is launched and behavior B2 begins evaluation for the trigger conditions (it waits for T0 to be triggered). When TO is triggered, B2 is activated and action A2 is launched.

Behavior B3 which contains a trigger graph. In behavior B3 action A1 is launched only when conditions of trigger T2 and, then of trigger TO are met. In the case of behavior B1, when the T1 is triggered, actions A0 and A1 are launched, because action A0 has a child action A1 and actions are not time-dependent. A delay between their launch is possible though, but in this example, they are launched simultaneously. The interpretation of this example is simplified for the sake of understating. The following table proposes a representation of the scene in glTF format.

```
  {
    ″scene″: 0,
    ″nodes″ : [
```

| | |
|---|---|
| { | /* node 0 is a CAMERA node */ |

```
        ″camera″ : 0,
        ″name″ : ″Camera_Orientation″,
        ″translation″ : [
          10,
          20,
          24
        ],
        ″rotation″ : [
          −0.32,
          0.15,
          −0.03,
          0.94
        ]
      }
```

| | |
|---|---|
| { | /* node 1 is a MESH node */ |

```
        ″mesh″ : 1,
        ″name″ : ″Sphere_Red″,
        ″translation″ : [
          −3,
          0,
          −6.703279495239258
        ]
      }
```

| | |
|---|---|
| { | /* node 2 is a MESH node */ |

```
        ″mesh″ : 2,
        ″name″ : ″Rectangle_Blue ″,
        ″translation″ : [
          −5,
          0,
          −8
        ]
      }
    ],
    ″cameras″ : [
```

| | |
|---|---|
| { | /* This defines Camera 0. There is only one camera. */ |

```
        ″name″ : ″Camera″,
        ″perspective″ : {
          ″aspectRatio″ : 1.7777777777777777,
          ″yfov″ : 0.7175413670112324,
          ″zfar″ : 100,
          ″znear″ : 0.10000000149011612
        },
        ″type″ : ″perspective″
      }
    ],
    ″scenes″: [
      {
        ″extensions″: {
          ″MPEG_scene_interactivity″: {
            ″triggers″: [
```

| | |
|---|---|
| { | /* trigger 0 is a PROXIMITY trigger */ |

```
                ″type″ : ″TRIGGER_PROXIMITY″,
                ″distanceLowerLimit″ : 0.0,
                ″distanceUpperLimit″ : 1.0,
                ″nodes″ : [0,1],
                “parent”:[2]
              },
```

| | |
|---|---|
| { | /* trigger 1 is a VISIBILITY trigger */ |

```
                ″type″ : ″TRIGGER_VISIBILITY″,
                ″cameraNode″: 0
                ″nodes″ :
              },
```

| | |
|---|---|
| { | /* trigger 2 is a VISIBILITY trigger */ |

```
                ″type″ : ″TRIGGER_VISIBILITY″,
                ″cameraNode″: 0
                ″nodes″ : [1],
```

| | |
|---|---|
| ″parent″: [−1], | /* trigger 2 is a root of the trigger hierarchy */ |
| ″children″: [0] | /* trigger 0 is a child of trigger 2 */ |

```
              },
            ],
            ″actions″: [
```

| | |
|---|---|
| { | /* action 0 is an ACTIVATE action */ |

```
                ″type″: ″ACTION_ACTIVATE″,
                ″activationStatus″: 0,
                ″nodes″: [1],
```

| | |
|---|---|
| ″parent″: [−1], | /* action 0 is an root of the action hierarchy */ |
| ″children″: [1] | /* action 1 is a child of action 0 */ |

},

| | |
|---|---|
| { | /* action 1 is a TRANSFORM action */ |

```
                ″type″: ″ACTION_TRANSFORM″,
                ″transform″: [[1,0,0,0],[0,1,0,0],[0,0,1,0],[0,0,0,1]],
                ″nodes″: [1],
```

| | |
|---|---|
| ″parent″: [0] | /* action 1 is a child of action 0 */ |

},

| | |
|---|---|
| { | /* action 2 is a SET MATERIAL action */ |

```
                ″type″: ″ACTION_SET_MATERIAL″,
                ″material″: 0,
                ″nodes″: [1],
              }
            ],
            ″behaviors″: [
```

| | |
|---|---|
| { | /* Definition for behavior 0 */ |
| ″triggers″: [1], | /* when trigger 1 condition is satisfied... */ |
| ″actions″: [1], | /* action 1 is triggered */ |

```
                ″triggersCombinationControl″: ″#1″,
                ″triggersActivationControl″: ″TRIGGER ACTIVATE_O″,
                ″actionsControl″: 0,
                ″priority″: 1,
```

| | |
|---|---|
| ″parent″: [−1], | /* behavior 0 is a root behavior in the hierarchy */ |
| ″children″: [2] | /* behavior 2 is a child of behavior 0 */ |

},

| | |
|---|---|
| { | /* Definition for behavior 1 */ |
| ″triggers″: [1], | /* when trigger 1 condition is satisfied... */ |
| ″actions″: [0], | /* action 0 is triggered */ |

```
                ″triggersCombinationControl″: ″#1″,
                ″triggersActivationControl″: ″TRIGGER_ACTIVATE_O″,
                ″actionsControl″: 0,
                ″priority″: 1,
```

| | |
|---|---|
| ″parent″: [-1], | /* behavior 1 is a root behavior in the hierarchy */ |
| ″children″: [2] | /* behavior 2 is a child of behavior 1 */ |

},

| | |
|---|---|
| { | /* Definition for behavior 2 */ |
| ″triggers″: [0], | /* when trigger 0 condition is |

satisfied... */

| | |
|---|---|
| ″actions″: [2], | /* action 2 is triggered */ |

```
                ″triggersCombinationControl″: ″#1″,
                ″triggersActivationControl″: ″TRIGGER_ACTIVATE_O″,
                ″actionsControl″: 0,
                ″priority″: 1,
```

| | |
|---|---|
| ″parent″: [0, 1] | /* behavior 2 is a child of each of behaviors |

0 and 1 */
},

| | |
|---|---|
| { | /* Definition for behavior 3 */ |
| ″triggers″: [2], | /* when trigger 2 condition is satisfied */ |
| ″actions″: [1], | /* action 1 is triggered */ |

```
                ″triggersCombinationControl″: ″#1″,
                ″triggersActivationControl″: ″TRIGGER_ACTIVATE_O″,
                ″actionsControl″: 0,
                ″priority″: 1
              }
            ]
          }
        }
      }
    ]
  }
```

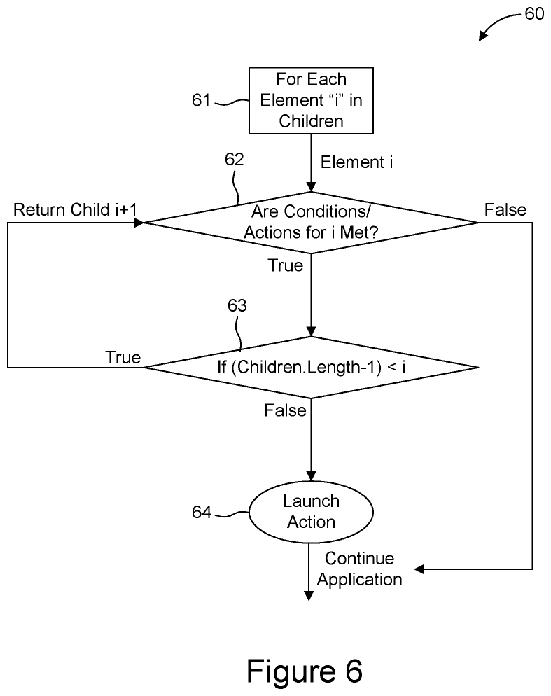

FIG. 6 illustrates a method 60 for processing a trigger graph according to the present principles. This figure is an example illustration of how a graph can iterate over the children's nodes when existing. In this example, if a trigger has “n” children triggers, the graph will wait for all the triggers condition to have been met before launching the associated actions. The actions are defined at the behavior level, and they are launched once all the triggers have been activated. At a step 61, the ith trigger is evaluated. If, at s step 62, the trigger does not have its conditions validated, the process continues to the next scene update and evaluates the same trigger until this is either activated or the application is over. Once the trigger is activated, it moves on to its next child at a step 63, if it exists, and recursively performs the same logic until all children have been activated/condition validated so start launching, at step 64, all actions associated with this hierarchy of triggers.

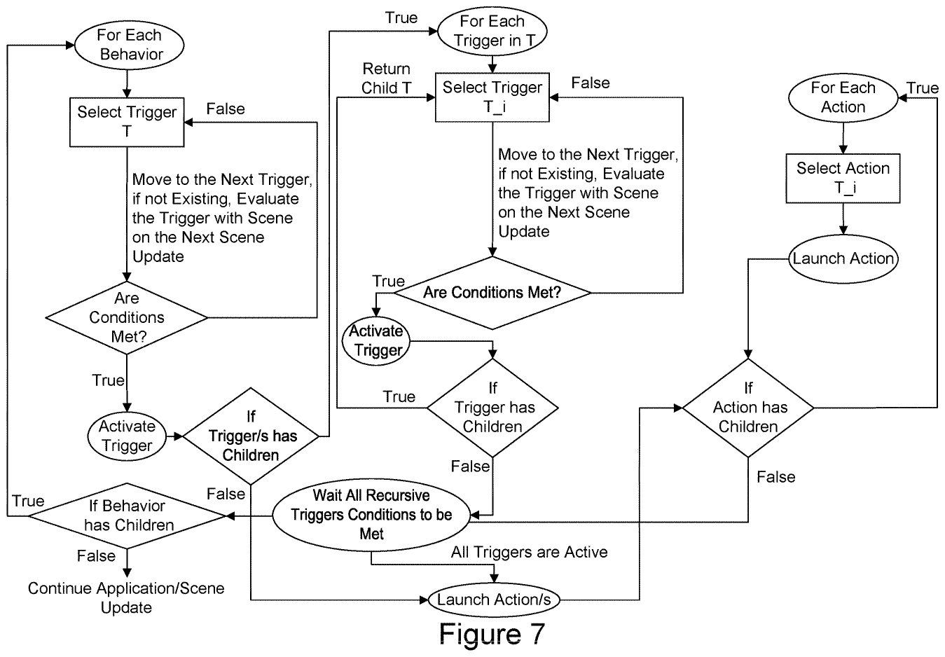

FIG. 7 is a representation of the processing model for the cascading events using a graph structure according to the present principles. This process represents the execution of a scenario in a sequential mode, where the children finish all their dependencies before moving to the next child. For a parallel scenario, each trigger runs in parallel and so their dependencies wait until all events have been triggered and actions have been launched before moving to the next behavior child nodes. If the root behavior has more than one child, it also is launched in parallel and so their triggers are evaluated. FIG. 7 depicts the processing model of the graph: the behavior defines the triggers and actions, and each trigger and action can have its own graph hierarchy. If this is true, the actions associated with a behavior will be launched only when the main triggers and their individual trigger graph conditions are valid. The processing model forces the state to wait until all triggers are active before launching the main actions and the dependent actions.

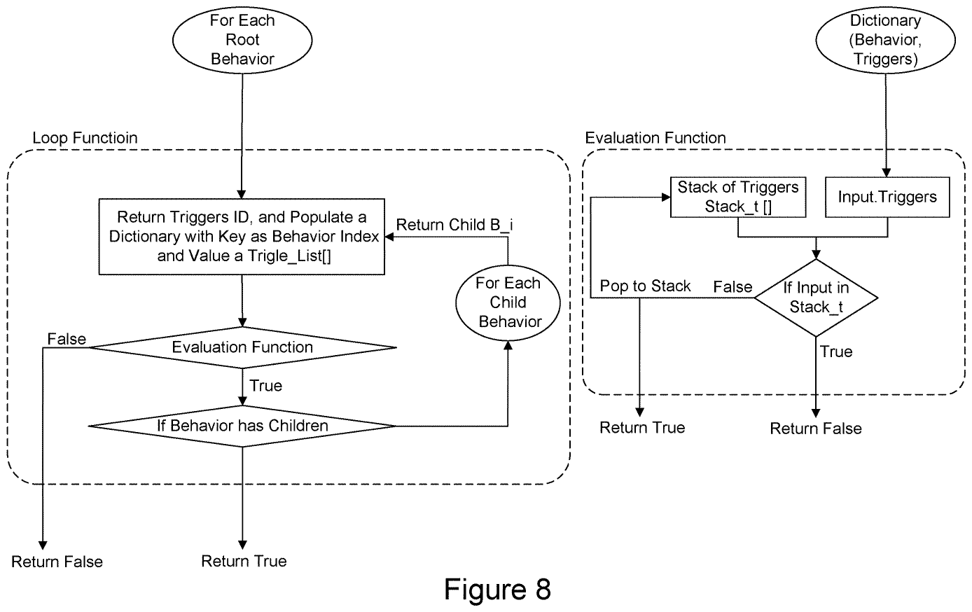

FIG. 8 illustrates the validation model to use prior to the execution of a scene description file according to the present principles. Given the complexity of graph models and the graph representation according to the present principles, it is possible to have invalid graphs, for example, leaf nodes that will not be activate because previous trigger condition have been met. This may be caused by the reusing of triggers between behaviors, which results in behavior graphs that are never executed and become redundant and complicated to read in a description file format. For this reason, a validation processing model that validates the correctness of an interactive graph structure is proposed. This model tests if a behavior graph is valid and if its processing has no dead-leaves (e.g., areas in the graph that cannot be reached). This model is a simple binary model that return “false” for invalid graphs, or “true” for valid graphs.

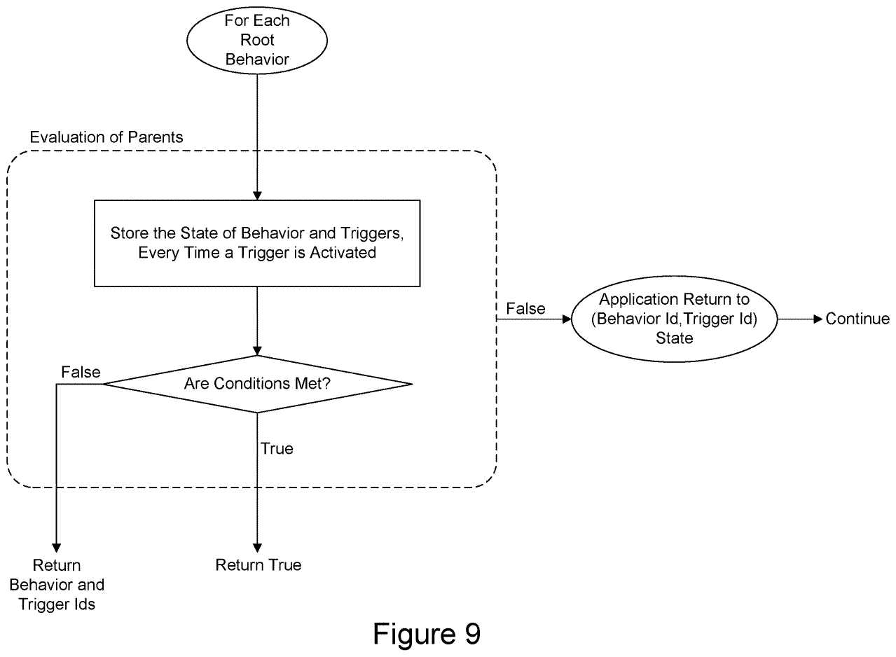

FIG. 9 illustrates a state validation model to evaluate the state of the hierarchical triggers conditions. Given the intricated nature of graphs and interactivity, this model is proposed to verify if the parent behaviors conditions are still valid at the current scene update. This enforces conditional cascading events that might be required for richer interactive scenes but that are not mandatory for the normal behavior of the graph. For every triggered activation, a state of behavior and trigger ids are cached in memory, and an evaluation is performed to check the current state of the original conditions. If the conditions are no longer met, the model returns the ids of behavior and triggers to force the application to return to a previous evaluation state.

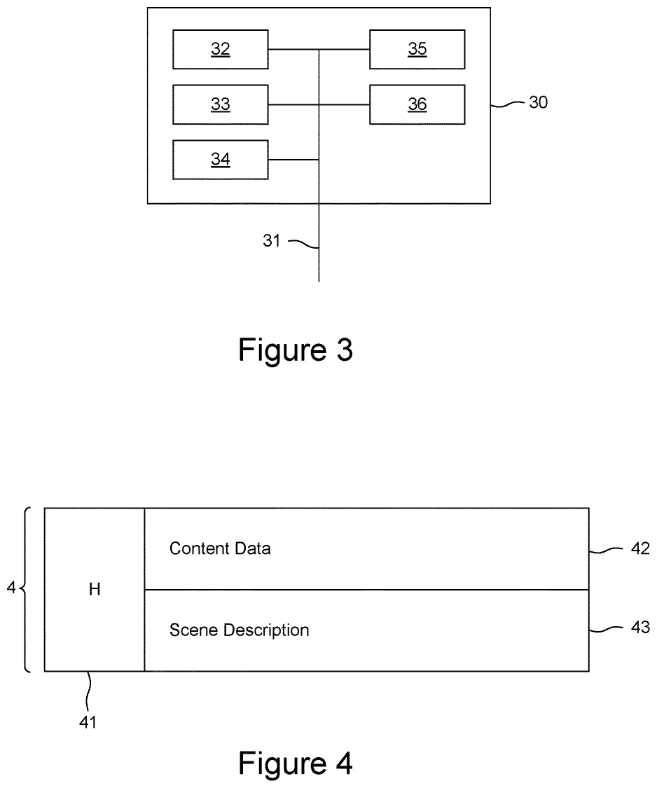

FIG. 3 shows an example architecture of an XR processing engine 30 which may be configured to implement the present principles. A device according to the architecture of FIGS. 6 to 9 is linked with other devices via their bus 31 and/or via I/O interface 36.

Device 30 comprises following elements that are linked together by a data and address bus 31: D a processor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 2), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method according to the present principles, and belongs to a set comprising:
a mobile device;
a communication device;
a game device;
a tablet (or tablet computer);
a laptop;
a still picture camera;
a video camera.

FIG. 4 shows an example of an embodiment of the syntax of a data stream encoding an extended reality scene description according to the present principles. FIG. 3 shows an example structure 4 of an XR scene description. The structure consists in a container which organizes the stream in independent elements of syntax. The structure may comprise a header part 41 which is a set of data common to every syntax element of the stream. For example, the header part comprises some of metadata about syntax elements, describing the nature and the role of each of them. The structure also comprises a payload comprising an element of syntax 42 and an element of syntax 43. Syntax element 42 comprises data representative of the media content items describes in the nodes of the scene graph related to virtual elements. Images, meshes and other raw data may have been compressed according to a compression method. Element of syntax 43 is a part of the payload of the data stream and comprises data encoding the scene description as described according to the present principles.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for cascading events in an extended reality scene, the method comprising:
obtaining a scene description comprising a scene graph, wherein nodes of the scene graph associate a list of behavior elements, wherein the nodes of the scene graph describe virtual objects of the extended reality scene, wherein a behavior element (i) associates one or more triggers a graph of actions elements and (ii) is a root behavior element or is a child behavior element of at least one different behavior element, and wherein a trigger is cascaded to child nodes of the scene graph;
activating root behavior elements;
for each activated behavior element, activating the one or more triggers of the activated behavior element;
when conditions of the activated one or more triggers are reached, activating the one or more triggers of child behavior elements of the activated behavior elements, if they exist, and inactivating the activated one or more triggers or, if not, executing actions of the graph of action elements of the activated behavior elements; and
when the actions are executed, activating the child behavior elements of the activated behavior elements, if they exist, and inactivating the activated behavior elements.

2. The method of claim 1, wherein a sequential mode is set up, and wherein a behavior element, a trigger element or an action element is activated only when a previous sibling element is inactivated.

3. The method of claim 1, wherein a parallel mode is set up, and wherein every child of a behavior element, a trigger element or an action element is activated when the element is inactivated.

4. The method of claim 1, wherein the one or more triggers are defined as a graph of combinations of triggers.

5. A device for managing cascading events in an extended reality scene, the device comprising a processor associated a memory, the processor being configured for:
obtaining a scene description comprising a scene graph, wherein nodes of the scene graph associate a list of behavior elements, wherein the nodes of the scene graph describe virtual objects of the extended reality scene, wherein a behavior element (i) associates one or more triggers a graph of actions elements and (ii) is a root behavior element or is a child behavior element of at least one different behavior element, and wherein a trigger is cascaded to the child nodes;
activating root behavior elements;
for each activated behavior element, activating the one or more triggers of the activated behavior element;
when conditions of the activated one or more triggers are reached, activating the one or more triggers of child behavior elements of the activated behavior elements, if they exist, and inactivating the activated one or more triggers or, if not, executing actions of the graph of action elements of the activated behavior elements; and
when the actions are executed, activating the child behavior elements of the activated behavior elements, if they exist, and inactivating the activated behavior elements.

6. The device of claim 5, wherein a sequential mode is set up, and wherein a behavior element, a trigger element or an action element is activated only when a previous sibling element is inactivated.

7. The device of claim 5, wherein a parallel mode is set up, and wherein every child of a behavior element, a trigger element or an action element is activated when the element is inactivated.

8. The device of claim 5, wherein the one or more triggers are defined as a graph of combinations of triggers.

9. The method of claim 2, wherein the one or more triggers are defined as a graph of combinations of triggers.

10. The method of claim 3, wherein the one or more triggers are defined as a graph of combinations of triggers.

11. The device of claim 6, wherein the one or more triggers are defined as a graph of combinations of triggers.

12. The device of claim 7, wherein the one or more triggers are defined as a graph of combinations of triggers.
